(19) United States
(12) Patent Application Publication
(10) Pub. No.: US 2016/0248495 A1
(43) Pub. Date: Aug. 25, 2016

(54) Radio Communication Apparatus and Radio Communication Method

(71) Applicant: NEC CORPORATION, Minato-ku, Tokyo (JP)

(72) Inventors: Jun SHIKIDA, Tokyo (JP); Naoto ISHII, Tokyo (JP)

(73) Assignee: NEC Corporation, Minato-ku, Tokyo (JP)

(21) Appl. No.: 15/031,798

(22) PCT Filed: May 22, 2014
(86) PCT No.: PCT/JP2014/063569

§ 371 Date: Apr. 25, 2016

(30) Foreign Application Priority Data
Nov. 29, 2013 (JP) 2013-247676

(51) Int. Cl. H04B 7/06; H04L 5/00; H04B 7/04

(52) U.S. Cl. CPC H04B 7/0617; H04B 7/0413; H04L 5/0007

(57) ABSTRACT

A radio communication apparatus provided with a plurality of antennas (101-1 to 101-M) includes: a channel information acquisition unit (105) that acquires information related to channels between the radio communication apparatus and another radio communication apparatus; an index calculation unit (106) that uses that information to calculate indices related to an angular spread of the channels; a weighting factor generation unit (107) that uses that information and the indices to generate weighting factors corresponding to the respective antennas; and a weighting factor multiplication unit (110) that multiplies signals to be processed by each antenna by the weighting factor corresponding to the antenna that processes the signal.

### TECHNICAL FIELD

The present invention relates to a radio communication apparatus and a radio communication method that are used in a radio communication system.

### BACKGROUND ART

In recent years, radio transmission technologies that employ a plurality of antennas are being investigated to effectively use radio frequencies. As one example, there is an adaptive array antenna technology that adaptively controls the directivity formed by the entirety of a plurality of antennas by adjusting the amplitude and phase of the signal processed at each antenna. If the amplitude and phase values are set based on the channels state, power can be radiated focused in the direction of good channel quality and communication quality can be improved. In this technology, the beam width of directivity can be narrowed and the degree of concentration of power that is radiated in a specific direction can be increased in proportion to the number of antennas employed.

Information relating to channels is necessary for forming directivity, and there are two methods of acquiring this information by a transmitter: in the first method, the state of the channels are estimated by a transmitter, and in the second method, the state of the channel is estimated by a receiver and then the estimated result is reported to the transmitter. Regardless of the method used, there is a time difference between estimating the state of the channels and executing the transmission that uses the directivity based on the estimated result. If the direction of good channel quality should fluctuate during this time difference, the direction of the main lobe of directivity that was formed at the time of transmission shifts from the direction of good channel quality and the communication quality is therefore degraded compared to the case in which directivity was able to be formed ideally based on the state of the channels at the time of transmission. In particular, when the beam width of directivity is narrow, the shift in direction is not contained within the beam width and tends to orient in the null or side lobe of directivity in the direction of good channel quality, and the amount of degradation of communication quality therefore tends to increase. As a countermeasure, a method can be considered for increasing the frequency of estimating the channels state to use information relating to channels that is as recent as possible, but this method is not preferable due to the increase in the amount of computation.

A method is investigated in Patent Document 1 for controlling the number of antennas that are used based on the degree of fluctuation of the reception power of signals exchanged between transmission/reception apparatuses in order to suppress deterioration of the communication quality due to fluctuation of the direction of good channel quality without increasing the frequency of estimating the channels state. In this method, the fluctuation of the direction of good channel quality is determined to be great when there is a large degree of fluctuation of reception power and the number of antennas used is decreased. By decreasing the number of antennas, the degree of concentration of power in a specific direction falls, but because the beam width of directivity broadens, major deterioration of the communication quality due to fluctuation of the direction of good channel quality is avoided.

### LITERATURE OF THE PRIOR ART

### Patent Documents

Patent Document 1: Japanese Unexamined Patent Application Publication No. 2008-278076

### SUMMARY OF THE INVENTION

### Problem to be Solved by the Invention

Nevertheless, the fluctuation of the direction of good channel quality is not necessarily also great when the fluctuation of received power is great. For example, the received power may fluctuate greatly when the angular spread of a channel is small, but the range of fluctuation of the direction of good channel quality is small. As a result, in the method described in Patent Document 1, the fluctuation of the direction of good channel quality cannot be accurately estimated, and the amount of degradation of the communication quality is great compared to a case in which directivity can be formed ideally based on the state of the channels at the time of transmission.

It is therefore an object of the present invention to provide a radio communication apparatus and a radio communication method that enable both an accurate estimation of the fluctuation of the direction of good channel quality and a reduction in the amount of deterioration of communication quality for a case in which directivity can be ideally formed based on the channels state at the time of transmission.

### Means for Solving the Problem

The radio communication apparatus according to the present invention is a radio communication apparatus that is provided with a plurality of antennas and includes:
a channel information acquisition unit that acquires information relating to channels with another radio communication apparatus;
an index calculation unit that uses the information to calculate indices relating to the angular spread of the channels;
a weighting factor generation unit that uses the information and the indices to generate weighting factors corresponding to each of the plurality of antennas; and
a weighting factor multiplication unit that multiplies the signals that are processed by each of the plurality of antennas by the weighting factors that correspond to antennas that process the signals.

The radio communication method according to the present invention is a radio communication method in a radio communication apparatus that is provided with a plurality of antennas and includes steps of:
acquiring information relating to channels with another radio communication apparatus;

using the information to calculate indices relating to the angular spread of the channels;

using the information and the indices to generate weighting factors corresponding to each of the plurality of antennas; and

multiplying the signals that are processed at each of the plurality of antennas by the weighting factors corresponding to the antennas that process the signals.

### Effect of the Invention

The present invention enables a reduction in the amount of deterioration of communication quality for a case in which directivity can be formed ideally based on the channels state at the time of transmission under communication conditions in which the state of the channel fluctuates.

### BRIEF DESCRIPTION OF THE DRAWINGS

FIG. 1 is a structural view showing the radio communication system in the first exemplary embodiment of the present invention.

FIG. 2 is a block diagram showing the functional configuration of a radio base station in the first exemplary embodiment of the present invention.

FIG. 3 is a flow chart describing an example of the reception operation of a radio base station in the first exemplary embodiment of the present invention.

FIG. 4 is a flow chart describing an example of the transmission operation of a radio base station in the first exemplary embodiment of the present invention.

FIG. 5 is a flow chart describing an example of the operation of the weighting factor generation unit in the first exemplary embodiment of the present invention.

FIG. 6 is a structural view showing the radio communication system in the second exemplary embodiment of the present invention.

FIG. 7 is a block diagram showing the functional configuration of a radio base station in the second exemplary embodiment of the present invention.

FIG. 8 is a flow chart for describing an example of the operation of the weighting factor generation unit in the second exemplary embodiment of the present invention.

FIG. 9 is a view showing the configuration of the antennas of a radio base station in the fourth exemplary embodiment of the present invention.

FIG. 10 is a view describing an example of setting weighting factors in the fourth exemplary embodiment of the present invention.

### BEST MODE FOR CARRYING OUT THE INVENTION

Exemplary embodiments of the present invention are next described while referring to the accompanying drawings. Although the radio communication system that is described in each of the following exemplary embodiments is assumed to conform to the OFDM (Orthogonal Frequency Division Multiplexing) mode, the present invention can be applied to radio communication systems that conform to other communication modes.

### (I) First Exemplary Embodiment

### (1.1) Explanation of Configuration

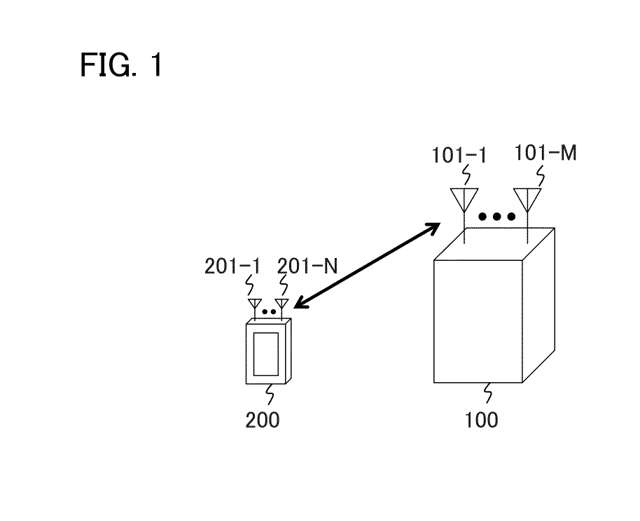

FIG. 1 is a structural view showing the radio communication system in the first exemplary embodiment of the present invention. As shown in FIG. 1, the radio communication system in the present exemplary embodiment includes radio base station 100 and radio terminal 200.

Radio base station 100 and radio terminal 200 are each assumed to be equipped with antennas 101-1-101-M and antennas 201-1-201-N, respectively. Here, M is an integer equal to or greater than 2 and N is an integer equal to or greater than 1 and satisfies the relation M≧N.

Radio base station 100 controls the directivity that is formed by antennas 101-1-101-M when transmitting a signal addressed to radio terminal 200 according to the state of the channels with radio terminal 200.

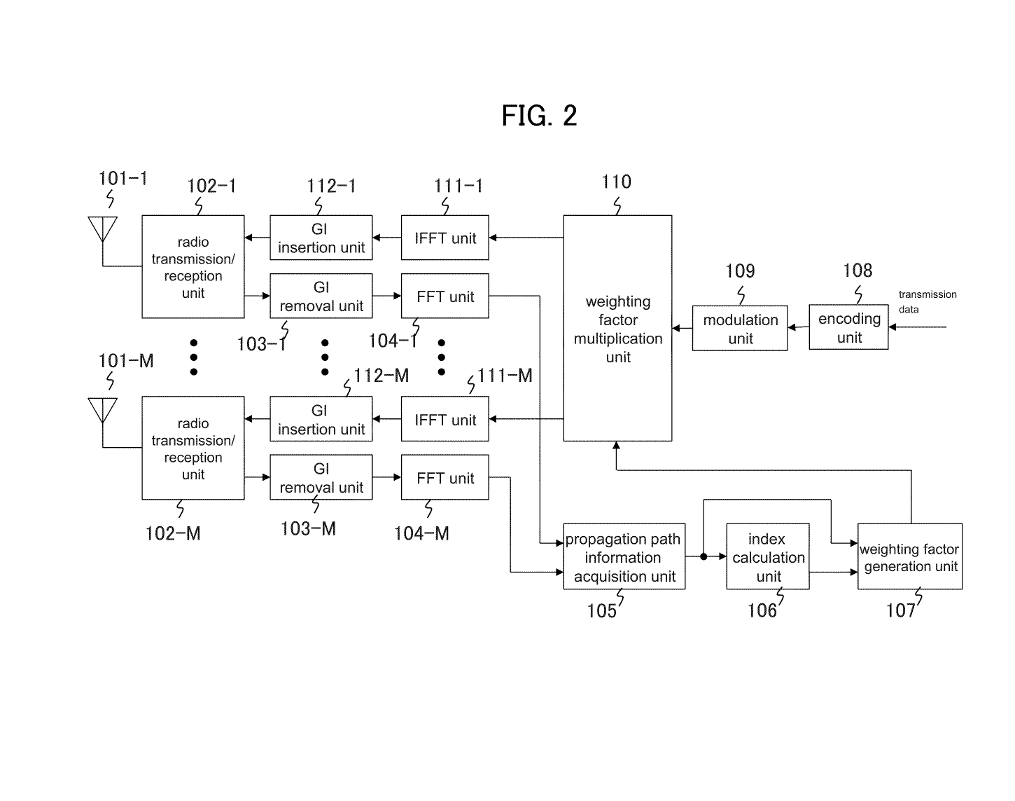

FIG. 2 is a block diagram showing the functional configuration of radio base station 100 in the present exemplary embodiment. As shown in FIG. 2, radio base station 100 in the present exemplary embodiment has: antennas 101-1-101-M, radio transmission/reception units 102-1-102-M, GI (Guard Interval) removal units 103-1-103-M, FFT (Fast Fourier Transform) units 104-1-104-M, channel information acquisition unit 105, index calculation unit 106, weighting factor generation unit 107, encoding unit 108, modulation unit 109, weighting factor multiplication unit 110, IFFT (Inverse Fast Fourier Transform) units 111-1-111-M, and GI insertion units 112-1-112-M.

Each of antennas 101-1-101-M receives a radio frequency signal that was transmitted by radio terminal 200.

Each of radio transmission/reception units 102-1-102-M corresponds to a respective antenna of antennas 101-1-101-M and converts the reception signal that is the signal received by the corresponding antenna to a baseband signal.

Each of GI removal units 103-1-103-M corresponds to a respective radio transmission/reception unit of radio transmission/reception units 102-1-102-M and removes GI from the reception signal that was converted to a baseband signal in the corresponding radio transmission/reception unit.

Each of FFT units 104-1-104-M corresponds to a respective GI removal unit of GI removal units 103-1-103-M, carries out a FFT upon the received signal from which GI has been removed by a corresponding GI removal unit, and converts the reception signal to the frequency domain signal.

Channel information acquisition unit 105 uses the plurality of reception signals that have been converted to signals of a frequency band in each of FFT units 104-1-104-M to acquire channel information that is information relating to the channels between radio base station 100 and radio terminal 200 that is another radio communication apparatus. The channel information is, for example, the channels frequency responses between each of antennas 101-1-101-M of radio base station 100 and each of antennas 201-1-201-N of radio terminal 200.

As methods for acquiring channel information, there are a first method in which radio base station 100 estimates the states of the channels and a second method in which radio base station 100 receives the states of the channels that were estimated by radio terminal 200. The appropriate method is used by taking into account factors such as the amount of computation required to acquire the channel information and the accuracy of the channel information.

Index calculation unit 106 uses the channel information that was acquired by channel information acquisition unit 105 to calculate an index relating to the angular spread of the channels. The index is not assumed to be the channel angular spread itself but a value that can be calculated by an amount of computation that is smaller than the actual angular spread of the channels. The index will be later explained in detail.

Weighting factor generation unit 107 uses the channel information that were acquired by channel information acquisition unit 105 and the indices that were calculated by index calculation unit 106 to generate weighting factors corresponding to each of antennas 101-1-101-M. A detailed explanation will be later given regarding the method of generating the weighting factors.

Encoding unit 108 encodes transmission data addressed to radio terminal 200. No particular limitations apply to the encoding method.

Modulation unit 109 modulates the transmission data that have been encoded in encoding unit 108. The modulation method is assumed to be a digital modulation method such as Phase Shift Keying (PSK) or Quadrature Amplitude Modulation (QAM).

Weighting factor multiplication unit 110, after duplicating the modulated signals that were generated in modulation unit 109 to generate signals that are to be processed at each of antennas 101-1-101-M, multiplies each of these signals by the weighting factors corresponding to each of antennas 101-1-101-M that were generated in weighting factor generation unit 107.

Each of IFFT units 111-1-111-M, corresponding to each of antennas 101-1-101-M, carries out an IFFT upon, from among the transmission signals that have been multiplied by weighting factors in weighting factor multiplication unit 110, the transmission signal that is to be processed at the corresponding antenna.

Each of GI insertion units 112-1-112-M, corresponding to IFFT units 111-1-111-M, inserts a GI in the transmission signal that has undergone the inverse fast Fourier transform in the corresponding IFFT unit.

Radio transmission/reception units 102-1-102-M, corresponding to each of GI insertion units 112-1-112-M, converts the transmission signals into which GI has been inserted by a corresponding GI insertion unit to a signal of a radio frequency band.

Each of antennas 101-1-101-M transmits a transmission signal that has been converted to a signal of a radio frequency band in the radio transmission/reception unit that corresponds to that antenna.

### (1.2) Explanation of the Operation

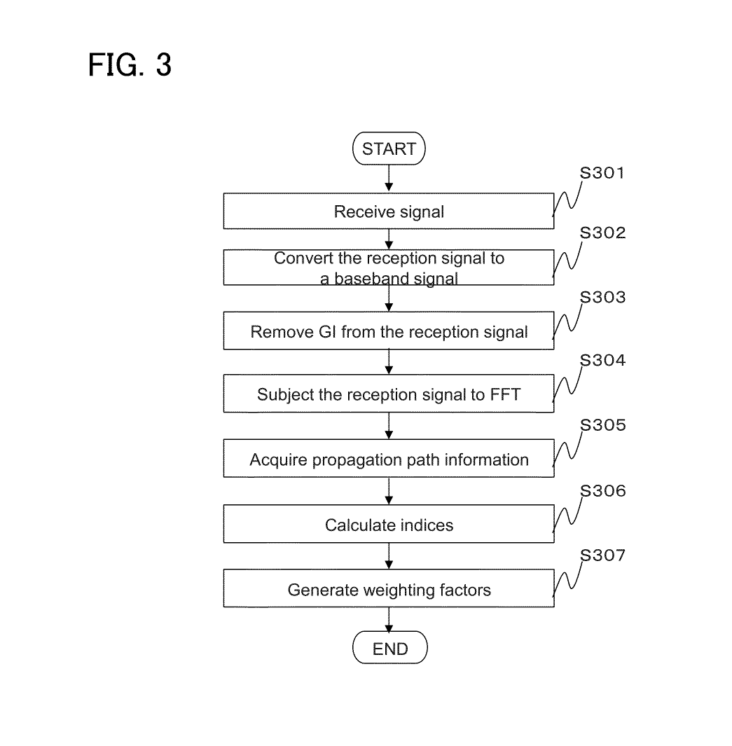

FIG. 3 is a flow chart describing an example of the reception operation in radio base station 100.

Each of antennas 101-1-101-M of radio base station 100 first receives a signal of a radio frequency band that was transmitted from each of antennas 201-1-201-N of radio terminal 200 and supplies the signal as a reception signal to the radio transmission/reception unit that corresponds to that antenna (Step S301).

Each of radio transmission/reception units 102-1-102-M receives the reception signal from the antenna that corresponds to that radio transmission/reception unit, converts the reception signal to a baseband signal, and supplies the baseband signal to the GI removal unit that corresponds to that radio transmission/reception unit (Step S302).

Each of GI removal units 103-1-103-M receives the reception signal from the radio transmission/reception unit that corresponds to that GI removal unit, removes the GI from the reception signal, and supplies the reception signal from which the GI was removed to the FFT unit that corresponds to that GI removal unit (Step S303).

Each of FFT units 104-1-104-M receives the reception signal from the GI removal unit that corresponds to that FFT unit, subjects the reception signal to a FFT, and supplies the reception signal that has undergone the FFT to channel information acquisition unit 105 (Step S304).

Channel information acquisition unit 105 receives the reception signals from each of FFT units 104-1-104-M and uses the reception signals to acquire channel information. Channel information acquisition unit 105 then supplies the channel information that was acquired to index calculation unit 106 and weighting factor generation unit 107 (Step S305).

Index calculation unit 106 receives the channel information from channel information acquisition unit 105 and uses the channel information to calculate an index. Index calculation unit 106 then supplies the calculated index to weighting factor generation unit 107 (Step S306).

Weighting factor generation unit 107 receives the channel information from channel information acquisition unit 105 and receives the index from index calculation unit 106. Weighting factor generation unit 107 then uses the channel information and index that were received to generate a plurality of weighting factors corresponding to each of antennas 101-1-101-M and supplies the plurality of weighting factors to weighting factor multiplication unit 110 (Step S307), whereby the reception operation is completed.

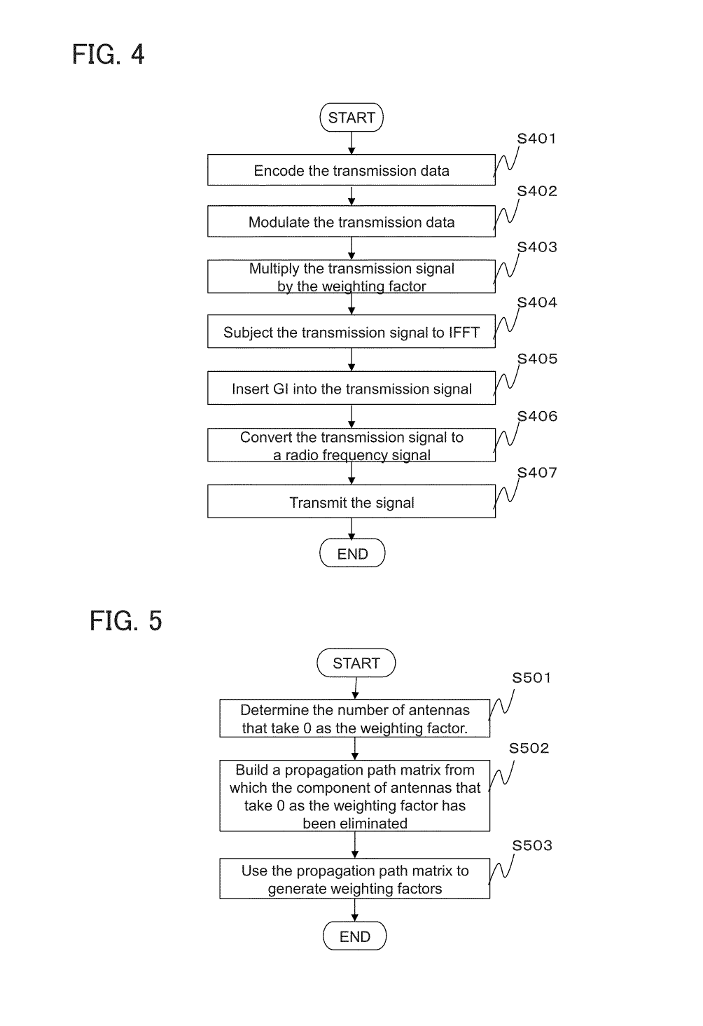

FIG. 4 is a flow chart describing an example of the transmission operation in radio base station 100.

Encoding unit 108 first receives transmission data addressed to radio terminal 200, encodes the transmission data, and then supplies the encoded data to modulation unit 109 (Step S401).

Modulation unit 109 receives the transmission data from encoding unit 108, modulates the transmission data, and supplies the modulated data to weighting factor multiplication unit 110 (Step S402).

Weighting factor multiplication unit 110 receives the modulated signal from modulation unit 109 and receives the weighting factors that were supplied from weighting factor generation unit 107 in Step S307 of FIG. 3. Weighting factor multiplication unit 110 duplicates the modulated signal to generate transmission signals that are to be processed at each of antennas 101-1-101-M and calculates weighting factors corresponding to the antennas that are to process the transmission signals for each of the transmission signals. Weighting factor multiplication unit 110 then supplies each of the transmission signals that were multiplied by the weighting factors to the IFFT units that correspond to the antennas that are to process the transmission signals (Step S403).

Each of IFFT units 111-1-111-M receives a transmission signal from weighting factor multiplication unit 110, subjects the transmission signal to IFFT, and supplies the transmission signal that has undergone the IFFT to the GI insertion unit that corresponds to that IFFT unit (Step S404).

Each of GI insertion units 112-1-112-M receives a transmission signal from the IFFT unit of IFFT units 111-1-111-M that corresponds to that GI insertion unit, inserts a GI into the transmission signal, and supplies the transmission signal into which the GI was inserted to the radio transmission/reception unit that corresponds to that GI insertion unit (Step S405).

Radio transmission/reception units 102-1-102-M each receive the transmission signals from corresponding GI insertion units 112-1-112-M, convert the transmission signals to radio frequency band signals, and supply the radio frequency band signals to the corresponding antennas of the radio transmission/reception units (Step S406).

Each of antennas 101-1-101-M receives a radio frequency band signal from the radio transmission/reception unit that corresponds to that antenna of radio transmission/reception units 102-1-102-M and transmits the signal (Step S407), thereby completing the transmission process.

### (1.3) Calculation of Indices

Actual examples of indices that relate to the angular spread of the channels that are calculated by index calculation unit 106 are next described. In each of the following examples, the index increases in proportion to an increase in the angular spread of the channel.

In the first example, index calculation unit 106 uses the channel information to find the correlation between any of antennas 101-1-101-M of radio base station 100 and calculates an index based on this correlation. More specifically, if the channel frequency response between antenna 101-m of radio base station 100 and antenna 201-n of radio terminal 200 is h_{n,m}, index calculation unit 106 calculates index p using the following Equation (1).

$$\begin{matrix}[ Numerical Expression 1 ] & \\ ρ = 1 - \frac{1}{( M - Δ m )} {\sum }_{m = 1}^{M - Δ m} \frac{\vert {\sum }_{n = 1}^{N} {h}_{n , m}^{*} {h}_{n , m} + Δ m \vert}{\sqrt{{\sum }_{n = 1}^{N} {\vert {h}_{n , m} \vert}^{2}} \cdot \sqrt{{\sum }_{n = 1}^{N} {\vert {h}_{n , m} + Δ m \vert}^{2}}} & ( 1 )\end{matrix}$$

Here, Δm is an integer equal to or greater than 1 but less than M that is determined in advance. In addition, the second term on the right side of Equation (1) corresponds to the correlation between, from among antennas 101-1-101-M of radio base station 100, antennas that are separated by Δm. Index ρ that is calculated by equation (1) is equal to or greater than 0 and equal to or less than 1.

In the second example, index calculation unit 106, based on the channel information, constructs a matrix that takes as components the frequency responses of the channels between antennas 101-1-101-M of radio base station 100 and antennas 201-1-201-N of radio terminal 200, finds eigenvalues of the products of this matrix and an Hermitian transpose, and calculates indices based on these eigenvalues. More specifically, if the N×M′ matrix in which the elements of n rows and m columns are frequency responses h_{n,m}, is assumed to be H, index calculation unit 106 uses the eigenvalue λᵢ (where 1≦i≦N) of the product of matrix H and the Hermitian transpose of matrix H to calculate index ρ based on the following equation (2).

$$\begin{matrix}[ Numerical Expression 2 ] & \\ ρ = \frac{{λ}_{2}}{{λ}_{1}} & ( 2 )\end{matrix}$$

Eigenvalue λᵢ satisfies the relation λ₁≧λ₂≧ . . . ≧λ_{N}. In addition, the index realized by Equation (2) can be calculated only when N is at least 2. Here, M′ corresponds to the number of antennas that contribute to the formation of directivity and is an integer equal to 2 or more and no greater than M. In addition, the value M′ is not necessarily limited to one value and a plurality of indices may be computed corresponding to each of the plurality of M′ by index calculation unit 106.

Although the elements of matrix H were the frequency responses corresponding to antennas 101-1-101-M′ of radio base station 100 in the above-described example, the elements may also be the frequency responses corresponding to M′ antennas that are aligned continuously. In addition, the indices computed by Equation (2) are equal to or greater than 0 and no greater than 1.

In the third example, index calculation unit 106 finds vectors that take as elements the frequency responses of the channels with antennas 101-1-101-M of radio base station 100 for each of antennas 201-1-201-N of radio terminal 200 based on channel information, and computes indices based on the angles formed between each of the vectors. More specifically, if the M′-dimension vector for which the m^{th} element is frequency response h_{n,m} is hₙ, index ρ is calculated from the next Equation (3).

$$\begin{matrix}[ Numerical Expression 3 ] & \\ ρ = \frac{{\sum }_{n = 1}^{N} ( 1 - \frac{\vert {h}_{n}^{H} {h}_{{n}^{′}} \vert}{‖ {h}_{n} ‖ \cdot ‖ {h}_{{n}^{′}} ‖} ) {‖ {h}_{n} ‖}^{2}}{{\sum }_{n = 1}^{N} {‖ {h}_{n} ‖}^{2}} & ( 3 )\end{matrix}$$

Here, the subscript n′ is:

$$\begin{matrix}[ Numerical Expression 4 ] & \\ {n}^{′} = arg {max}_{n} {‖ {h}_{n} ‖}^{2} & ( 4 )\end{matrix}$$

In the index calculated from Equation (3), as in the index calculated from Equation (2), M′ corresponds to the number of antennas that contribute to the formation of directivity and is an integer equal to or greater than 2 and no greater than M. In addition, M′ is not necessarily limited to one value, and index calculation unit 106 may calculate indices corresponding to each of a plurality of M′.

Although the elements of vector hₙ were the frequency responses corresponding to antennas 101-1-101-M′ of radio base station 100 in the above-described example, the elements of vector hₙ may also be the frequency responses that correspond to M′ antennas that are aligned continuously. In addition, the indices calculated in Equation (3) are equal to or greater than 0 and lower than 1.

In the first to third examples described hereinabove, indices were calculated based on channel information that was acquired at a particular time, i.e., based on an instantaneous state of the channels. However, when the state of the channels changes violently, the generation of weighting factors from indices that are averaged over time is thought to be more appropriate than from indices that are based on an instantaneous state of the channels.

For example, if the instantaneous index at time i is ρᵢ, and the forgetting coefficient is α (where 0≦α<1), index calculation unit 106 calculates the index at time i:

[Numerical Expression 5]

ρ̅ᵢ

based on the following Equation (5).

[Numerical Expression 6]

ρ̅ᵢ=(1−α)ρᵢ+αρ̅ᵢ₋₁ (5)

The past information that is necessary for calculating an index according to Equation (5) is only the index that was previously calculated, and there is consequently no need to store past channel frequency responses.

In addition, the indices described hereinabove can be calculated in a subcarrier that can acquire channel frequency responses. As a result, when indices relating to the angular spread of channels can be calculated for a plurality of subcarriers, index calculation unit 106 may calculate the average value or the maximum value of the indices for the plurality of subcarriers as the index.

### (1.4) Generation of Weighting Factor

FIG. 5 is a flow chart describing an actual example of the operation of weighting factor generation unit 107.

Weighting factor generation unit 107 uses the indices that were calculated in index calculation unit 106 to determine the number M⁽⁰⁾ of antennas that take 0 as the weighting factor (Step S501). At this time, weighting factor generation unit 107 increases the value of M⁽⁰⁾ in proportion to the angular spread of the channels.

Weighting factor generation unit 107 next constructs a channel from the elements of antennas, which take 0 as the weighting factor, have been eliminated based on the channel information that was acquired in channel information acquisition unit 105 and the number M⁽⁰⁾ of antennas that take 0 as the weighting factor that was determined in Step S501 (Step S502). At this time, weighting factor generation unit 107 constructs a channel matrix such that the elements of (M−M⁽⁰⁾) antennas from which antennas that take 0 as the weighting factor have been eliminated are aligned continuously.

Weighting factor generation unit 107 then uses the channel matrix that was constructed in Step S502 to generate a weighting factor that is used when transmitting signals addressed to radio terminal 200 (Step S503) and thus completes the process.

Details regarding the processes of Step S501 and Step S503 are next explained.

Actual examples of the method of determining the number M⁽⁰⁾ of antennas that take 0 as the weighting factor in Step S501 are first described.

In the first example, weighting factor generation unit 107 uses one index to determine the number M⁽⁰⁾ of antennas that take 0 as the weighting factor. More specifically, when the index is ρ and the maximum value of M⁽⁰⁾ is M⁽⁰⁾ₘₐₓ, weighting factor generation unit 107 determines M⁽⁰⁾ using the following Equation (6). It is assumed that M⁽⁰⁾ₘₐₓ has been determined in advance.

[Numerical Expression 7]

M⁽⁰⁾=└Mₘₐₓ⁽⁰⁾ρ┘ (6)

However, in Equation (6),

[Numerical Expression 8]

└x┘

indicates the maximum integer among integers equal to or less than x.

In the second example, weighting factor generation unit 107 uses a plurality of indices to determine the number M⁽⁰⁾ of antennas that take 0 as the weighting factor. Here, the plurality of indices is assumed to refer to the plurality of indices that are calculated using Equation (2) or (3) for each number of antennas that contribute to the formation of directivity. When the index for a case in which the number of antennas that contribute to the formation of directivity is (M−m⁽⁰⁾) is:

[Numerical Expression 9]

ρ_{M-m}_{⁽⁰⁾}

and the threshold value is ρₜₕ, weighting factor generation unit 107 determines the minimum m⁽⁰⁾ that satisfies the following Equation (7) when m⁽⁰⁾ is changed from 0 to M−2 to be the number M⁽⁰⁾ of antennas that take 0 as the weighting factor.

[Numerical Expression 10]

ρ_{M-m}_{⁽⁰⁾}<ρₜₕ (7)

When the number M⁽⁰⁾ of antennas that take 0 as the weighting factor is large, the beam width of directivity that is formed spreads and the degree of concentration of the power of a transmission signal in a specific direction decreases. As a result, weighting factor generation unit 107 preferably controls M⁽⁰⁾ according to the channel information such that the received signal power in radio terminal 200 does not become excessively weak. For example, weighting factor generation unit 107 determines the maximum m⁽⁰⁾ that satisfies the following Equation (8) when m⁽⁰⁾ is changed from 0 to M−2 as the upper limit of the number M⁽⁰⁾ of antennas that take 0 as the weighting factor.

$$\begin{matrix}[ Numerical Expression 11 ] & \\ \frac{M - {m}^{( 0 )}}{M} {\sum }_{n = 1}^{N} {\sum }_{m = 1}^{M} {\vert {h}_{n , m} \vert}^{2} > β & ( 8 )\end{matrix}$$

In Equation (8), h_{n,m} is the channel frequency response between antenna 101-m of radio base station 100 and antenna 201-n of radio terminal 200, and β is a threshold value that is determined in advance.

An example of the method of generating a weighting factor in Step S503 is next described. In the interest of simplifying the explanation in the following explanation, it is assumed that the antennas that take 0 as the weighting factor are antennas 101-(M-M⁽⁰⁾+1)-101-M and the elements of the n^{th} row m^{th} column of N×(M-M⁽⁰⁾) matrix H that was constructed in Step S502 is h_{n,m}.

In the first example, weighting factor generation unit 107 first performs singular value decomposition of matrix H as in the following Equation (9):

[Numerical Expression 12]

H=UΣN^{H} (9)

Here, U is an N-dimension unitary matrix having the left singular vectors of matrix H as column vectors, Σ is an N×(M−M⁽⁰⁾) matrix in which the diagonal elements are singular values of H, and moreover, the off-diagonal elements are 0, and V is a (M−M⁽⁰⁾)-dimension unitary matrix having the right singular vectors of matrix H as the column vectors.

Weighting factor generation unit 107 then uses the right singular vector v₁ that corresponds to the maximum singular value to find the M-dimension weighting factor vectors w having weighting factors corresponding to each antenna as elements as in the following Equation (10):

$$\begin{matrix}[ Numerical Expression 13 ] & \\ w = ( \begin{matrix}{v}_{1} \\ {0}_{{M}^{( 0 )}}\end{matrix} ) & ( 10 )\end{matrix}$$

Here,

[Numerical Expression 14]

0_{M}⁽⁰⁾

is the M⁽⁰⁾-dimension zero vector. The right singular vector v₁ can be derived from the eigenvalue decomposition of the products of matrix H^{H} and matrix H.

In the second example, matrix H is represented as in the following Equation (11):

[Numerical Expression 15]

H^{T}=(h₁ . . . h_{N}) (11)

and weighting factor generation unit 107 uses, from among vectors hₙ (where 1≦n≦N), vector h_{n′} at which the norm is a maximum to find weighting factor vector w based on the following Equation (12).

$$\begin{matrix}[ Numerical Expression 16 ] & \\ w = ( \begin{matrix}\frac{{h}_{{n}^{′}}^{*}}{‖ {h}_{{n}^{′}} ‖} \\ {0}_{{M}^{( 0 )}}\end{matrix} ) & ( 12 )\end{matrix}$$

### (1.4) Effects

According to the present exemplary embodiment as described hereinabove, weighting factors that correspond to each of antennas 101-1-101-M of radio base station 100 are generated based on indices that are related to the angular spread of the channels. As a result, fluctuation of the direction of good channel quality can be accurately estimated to form directivity and the amount of deterioration of communication quality for a case in which ideal directivity is formed can be decreased.

In the present exemplary embodiment, moreover, indices are calculated based on the correlation with antennas 101-1-101-M of radio base station 100, whereby fluctuation of the direction of good channel quality can be accurately estimated.

Further, in the present exemplary embodiment, indices are calculated based on the eigenvalues of the products of a matrix that takes as its components the frequency responses between radio base station 100 and radio terminal 200 and an Hermitian transpose of the matrix, whereby fluctuation of the direction of good channel quality can be accurately estimated.

In the present exemplary embodiment, moreover, indices are calculated based on the angles formed between vectors that take as elements the channels frequency responses that are constructed for each of antennas 201-1-201-N of radio terminal 200 with antennas 101-1-101-M of radio base station, whereby the fluctuation of the direction of good channel quality can be accurately estimated.

In addition, in the present exemplary embodiment, indices that are related to the angular spread of channels and that are averaged over time or indices that are related to the angular spread of channels and that are averaged over frequencies are calculated as the indices, whereby the fluctuation in the direction of good channel quality can be estimated with greater accuracy.

In the present exemplary embodiment, moreover, the beam width of directivity that is formed by antennas 101-1-101-M of radio base station 100 is adjusted based on indices, whereby the amount of deterioration of communication quality for a case in which ideal directivity is formed can be decreased.

In the present exemplary embodiment, moreover, because the weighting factor is set to 0 only for a number that accords with the indices and because the beam width of directivity that is formed by antennas 101-1-101-M of radio base station 100 is adjusted, and then the beam width can be easily adjusted.

In the present exemplary embodiment, moreover, because weighting factors are increasingly set to 0 with increasing angular spread of channels, the adjustment of the beam width can be appropriate for the fluctuation of the direction of good channel quality.

Finally, in the present exemplary embodiment, an upper limit of the number of weighting factors that are set to 0 is determined based on channel information, whereby excessive weakening of the received signal power in radio terminal 200 can be prevented.

### (2) Second Exemplary Embodiment

In the second exemplary embodiment of the present invention, explanation regards a radio communication system in which a plurality of data blocks are transmitted by spatial multiplexing.

### (2.1) Explanation of Configuration

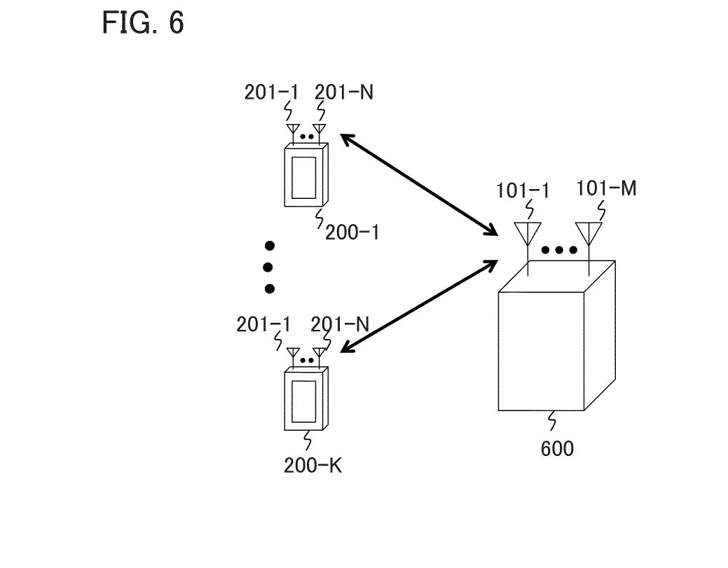

FIG. 6 is a structural diagram showing the radio communication system in the second exemplary embodiment of the present invention. In FIG. 6, constructions that are identical to those of FIG. 1 are given the same reference numbers and redundant explanation is omitted.

In contrast with the radio communication system in the first exemplary embodiment shown in FIG. 1, the radio communication system in the present exemplary embodiment shown in FIG. 6 has radio base station 600 in place of radio base station 100 and a plurality of radio terminals 200. In FIG. 6, there are K radio terminals 200, each of these K radio terminals 200 being referred to as radio terminals 200-1-200-K.

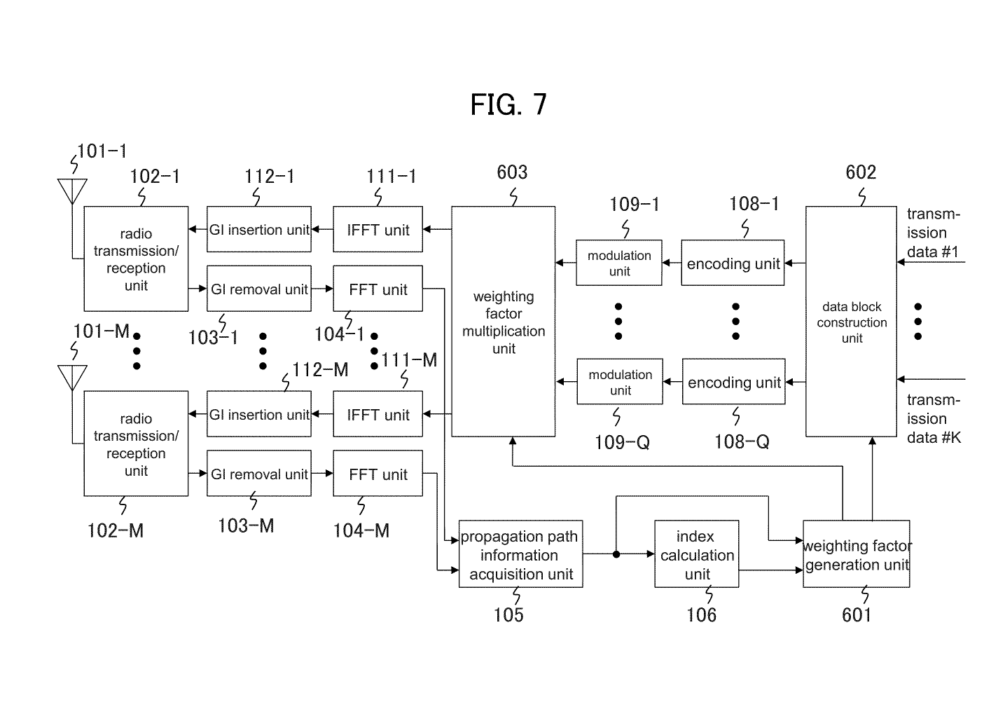

FIG. 7 is a block diagram showing the functional configuration of radio base station 600 in the present exemplary embodiment. In FIG. 7, constructions identical to those of FIG. 2 are given the same reference numbers and redundant explanation is omitted.

Radio base station 600 shown in FIG. 7 differs from radio base station 100 in the first exemplary embodiment shown in FIG. 2 in that it is provided with weighting factor generation unit 601 in place of weighting factor generation unit 107, is newly provided with data block construction unit 602, is provided with a plurality of each of encoding units 108 and modulation units 109, and is provided with weighting factor multiplication unit 603 in place of weighting factor multiplication unit 110. In FIG. 7, there are a number Q of each of encoding units 108 and modulation units 109, these Q encoding units 108 and Q modulation units 109 being respectively referred to as encoding units 108-1-108-Q and modulation units 109-1-109-Q.

Weighting factor generation unit 601 determines a number L of data blocks that are to undergo spatial multiplexing and transmission based on indices that are calculated in index calculation unit 106. Here, L is equal to or less than Q.

Data block construction unit 602 constructs the number L of data blocks that was determined in weighting factor generation unit 601 from a plurality of items of transmission data for radio terminals 200-1-200-K.

The L encoding units 108-1-108-L from among encoding units 108-1-108-Q encode respective data blocks that were constructed in data block construction unit 602.

Each of modulation units 109-1-109-Q corresponds to a respective encoding unit of encoding units 108-1-108-Q, and L modulation units 109-1-109-L from among modulation units 109-1-109-Q modulate respective data blocks that were encoded in the corresponding encoding unit.

Weighting factor multiplication unit 603 makes M duplications (for the number M of antennas) of the modulated signals corresponding to each of the data blocks that were generated in modulation units 109-1-109-L, and multiplies these (L×M) modulated signals by the weighting factors that were generated in weighting factor generation unit 107. Weighting factor multiplication unit 603 then adds together the L modulated signals after the multiplication of the corresponding weighting factors for each of antennas 101-1-101-M.

### (2.2) Determination of Data Blocks for Spatially Multiplexed Transmission and Generation of Weighting Factors

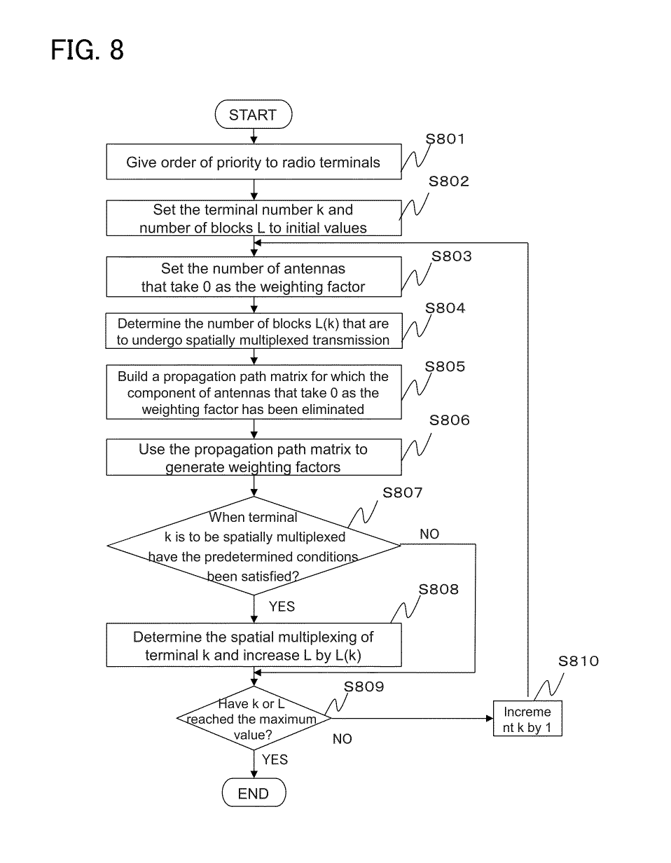

FIG. 8 is a flow chart for describing an example of the operation of weighting factor generation unit 601.

As shown in FIG. 8, weighting factor generation unit 601 first gives the order of priority to radio terminals 200-1-200-K based on channel information and the frequency of assignment of radio resources to each of radio terminals 200-1-200-K (Step S801). Weighting factor generation unit 601 is here assumed to give a terminal number to each of radio terminals 200-1-200-K as the order of priority in the preferential order of data transmission.

Weighting factor generation unit 601 next sets initial value 1 that is the highest order of priority as terminal number k and sets initial value 0 as the number L of data blocks that are to be transmitted by spatial multiplexing (Step S802).

Weighting factor generation unit 601 then, when transmitting signals addressed to the radio terminal of terminal number k, determines the number M⁽⁰⁾(k) of antennas that take 0 as the weighting factor based on the indices that were calculated in index calculation unit 106 (Step S803). A method identical to the method of determining the number M⁽⁰⁾ of antennas that take 0 as the weighting factor in the first exemplary embodiment can be used as the method of determining M⁽⁰⁾(k).

Weighting factor generation unit 601 then uses the channel information that was acquired by channel information acquisition unit 105 and the number M⁽⁰⁾(k) of antennas that take 0 as the weighting factor that was determined in Step S803 to determine the number L(k) of data blocks when transmitting signals addressed to the radio terminal of terminal number k (Step S804). For example, if the maximum value of the number of data blocks is Lₘₐₓ, weighting factor generation unit 601 finds L(k) using the following Equation (13).

$$\begin{matrix}[ Numerical Expression 17 ] & \\ L ( k ) = min ( N , {L}_{max} - L , ⌊ \frac{M}{M - {M}^{( 0 )} ( k )} ⌋ ) & ( 13 )\end{matrix}$$

Because the transmission power per data block decreases and the reception power declines in proportion to the increase of the number of data blocks L(k), weighting factor generation unit 601 may limit the number of data blocks based on the channel quality. In addition, the maximum value Lₘₐₓ of the number of data blocks is, for example, the number Q of modulation units 109 and encoding units 108.

Weighting factor generation unit 601 next constructs a channel matrix in which the components of antennas that take 0 as the weighting factor are removed (Step S805). At this time, weighting factor generation unit 601 continuously lines up elements of (M-M⁽⁰⁾(k)) antennas in which antennas that take 0 as the weighting factor are removed, and moreover, constructs a channel matrix such that there is no repetition among L(k) data blocks.

Weighting factor generation unit 601 next uses the channel matrix that was constructed in Step S805 to generate M-dimension weighting factor vectors w(k, j) (where 1≦j≦L(k)) that are used when transmitting each data block to the radio terminal of terminal number k (Step S806). For example, as in the first exemplary embodiment, weighting factor generation unit 601 uses the right singular vector that was acquired from the singular value decomposition of the channel matrix to generate M-dimension weighting factor vectors w(k, j).

Weighting factor generation unit 601 then uses the channel information and weighting factor vectors to judge whether the predetermined condition is satisfied when it is assumed that the signals addressed to the radio terminal of terminal number k are spatially multiplexed and transmitted (Step S807). The predetermined conditions are, for example, that the communication quality corresponds to data blocks for which spatially multiplexed transmission has already been determined and that each of the data blocks addressed to the radio terminal of terminal number k surpasses a predetermined threshold value. More specifically, when the terminal number of the radio terminal corresponding to data blocks for which spatially multiplexed transmission has already been determined and terminal number k are consolidated as i, the communication quality for data blocks j′ of the radio terminal of terminal number i′ is γ(i′, j′), the threshold value is γₜₕ, the N×M matrix in which the element of the n^{th} row and m^{th} column is the frequency response between antenna 101-m of radio base station 600 and antenna 201-n of radio terminal 200-i′ is and the noise power is N₀, the predetermined condition is represented as shown in the following Equation (14).

$$\begin{matrix}[ Numerical Expression 18 ] & \\ γ ( {i}^{′} , {j}^{′} ) = \frac{{‖ {H}_{{i}^{′}} w ( {i}^{′} , {j}^{′} ) ‖}^{2}}{{\sum }_{i \neq j}^{ } {\sum }_{j = 1}^{L ( i )} {‖ {H}_{{i}^{′}} w ( i , j ) ‖}^{2} + {N}_{0} {\sum }_{i}^{ } L ( i )} > {γ}_{th} & ( 15 )\end{matrix}$$

When the predetermined condition is satisfied (“YES” in Step S807), weighting factor generation unit 601 determines to perform spatially multiplexed transmission of the data blocks addressed to the radio terminal of terminal number k and adds L(k) to the number L of data blocks (Step S808), and then judges whether terminal number k or data block number L is the maximum value (Step S809).

On the other hand, when the predetermined condition is not satisfied (NO in Step S807), weighting factor generation unit 601 carries out Step S809 without carrying out the process of Step S808.

When terminal number k and the number L of data blocks are not the maximum values (NO in Step S809), weighting factor generation unit 601 adds 1 to the terminal number (Step S810) and returns to the process of Step S803.

On the other hand, when the terminal number k or the number L of data blocks is the maximum value (YES in Step S809), weighting factor generation unit 601 ends the process.

### (2.3) Effects

As described hereinabove, according to the present exemplary embodiment, the spatially multiplexed transmission of a plurality of data blocks in accordance with indices enables an improvement in the communication speed in addition to an improvement in the effects of the first exemplary embodiment.

### (3) Third Exemplary Embodiment

In the third exemplary embodiment of the present invention, the antennas of a radio base station are constituted by antennas for vertical polarization and antennas for horizontal polarization, and weighting factors for multiplying signals that are processed at each antenna are generated with consideration given to the angular spread of channels for each vertically and horizontally polarization.

(3.1) Configuration

The radio communication system and radio base station in the present exemplary embodiment have the same configuration as the radio communication system and radio base station 100 in the first exemplary embodiment shown in FIG. 1 and FIG. 2, respectively, but antennas 101-1-101-M in radio base station 100 are divided between antennas for vertical polarization and antennas for horizontal polarization, and index calculation unit 106 and weighting factor generation unit 107 carry out processing with consideration given to the angular spread of channels for each of vertically polarized waves and horizontally polarized waves.

Index calculation unit 106 uses the channel information that was acquired by channel information acquisition unit 105 to calculate indices for each of the vertically polarized wave component and the horizontally polarized wave component. In the calculation of the indices, any of Equations (1), (2), and (3) may be used, as in the first exemplary embodiment. At this time, when calculating indices for a vertically polarized wave component, index calculation unit 106 uses frequency responses that correspond to the vertical polarization antennas and uses frequency responses that correspond to horizontal polarization antennas when calculating indices for a horizontally polarized wave component.

Weighting factor generation unit 107 generates weighting factors based on the indices for each polarized wave component. At this time, weighting factor generation unit 107 may generate weighting factors by carrying out the same operations as the operations described using FIG. 5, but determines the number of antennas that take 0 as the weighting factor for each polarized wave component and continuously aligns the elements of antennas that do not take 0 as the weighting factor in the antennas for each polarization in the channel matrix.

### (3.2) Effect

Due to the calculation of indices for each vertically and horizontally polarization as described hereinabove, the present exemplary embodiment enables the generation of weighting factors that multiply signals processed at each antenna with consideration given to the angular spread of channels for each vertically and horizontally polarization. Accordingly, the amount of deterioration of communication quality can be reduced for a case in which ideal directivity is formed in an environment in which antennas are configured for vertical polarization and for horizontal polarization.

### (4) Fourth Exemplary Embodiment

In the fourth exemplary embodiment of the present invention, antennas are used that are two-dimensionally disposed in the horizontal direction and vertical direction, and weighting factors that multiply signals processed in each antenna are generated with consideration given to the angular spread of channels for each direction.

### (4.1) Configuration

The radio communication system and radio base station in the present exemplary embodiment have the same configuration as the radio communication system and radio base station in the first exemplary embodiment shown in FIG. 1 and FIG. 2, respectively, but antennas 101-1-101-M in the radio base station of the present exemplary embodiment are arranged two-dimensionally, and index calculation unit 106 and weighting factor generation unit 107 carry out processing based on indices for each of the horizontal direction and vertical direction.

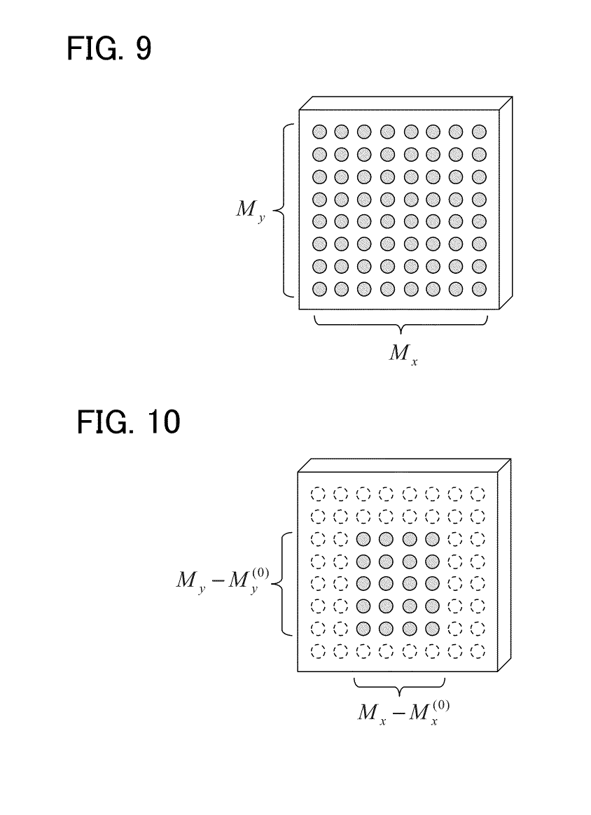

FIG. 9 shows the configuration of antennas of the present exemplary embodiment. As shown in FIG. 9, antennas 101-1-101-M are arranged two-dimensionally (M=Mₓ×M_{y}) with Mₓ antennas in the horizontal direction, which is the first direction, and M_{y} antennas in the vertical direction, which is the second direction.

Index calculation unit 106 calculates indices for each of the horizontal direction and vertical direction based on channel information. When calculating indices, index calculation unit 106 may use any of Equations (1), (2), and (3) shown in the first exemplary embodiment.

When using Equation (1), index calculation unit 106 calculates indices for the horizontal direction based on the correlation between antennas separated in the horizontal direction and calculates indices for the vertical direction based on the correlation between antennas separated in the vertical direction.

When using Equation (2) or (3), index calculation unit 106 calculates indices for the horizontal direction based on frequency responses corresponding to antennas that are continuous in the horizontal direction and calculates indices for the vertical direction based on frequency responses corresponding to antennas continuous in the vertical direction.

Weighting factor generation unit 107 uses the indices for each of the horizontal direction, and vertical direction to generate weighting factors. At this time, weighting factor generation unit 107 may generate weighting factors similarly to the operations of the first exemplary embodiment that were described using FIG. 5, but the number of antennas that take 0 as the weighting factor is determined for each of the horizontal direction and vertical direction and the components of antennas in which the weighting factor is not set to 0 are aligned continuously in each of the horizontal direction and vertical direction in the channel matrix, as shown in FIG. 10. In FIG. 10, Mₓ⁽⁰⁾ and M_{y}⁽⁰⁾ are the numbers of antennas that take 0 as the weighting factor for each of the horizontal direction and vertical direction, respectively.

### (4.2) Effect

As described hereinabove, because indices are calculated for each of the horizontal direction and vertical direction, the present exemplary embodiment allows weighting factors that multiply signals that are processed at each antenna to be generated with consideration given to the angular spread of channels with respect to each of the horizontal direction and vertical direction. Accordingly, the amount of deterioration of communication quality can be reduced for a case in which ideal directivity is formed in an environment of using antennas arranged two-dimensionally in the horizontal direction and vertical direction.

In each of the exemplary embodiments described above, the configurations shown in the figures are merely examples, and the present invention is not limited to these configurations.

In addition, although all or a portion of each of the above-described exemplary embodiments can be described as shown in following notes, the present invention is not limited to the following description.

### Note 1

The radio communication apparatus is a radio communication apparatus provided with a plurality of antennas and has:

a channel information acquisition unit that acquires information relating to channels with another radio communication apparatus;

an index calculation unit that uses the information to calculate indices relating to the angular spread of the channels;

a weighting factor generation unit that uses the information and the indices to generate weighting factors corresponding to each of the plurality of antennas; and

a weighting factor multiplication unit that multiplies the signals that are processed by each of the plurality of antennas by the weighting factors that correspond to the antennas that process the signals.

### Note 2

In the radio communication apparatus described in Note 1, the index calculation unit uses the information to find a correlation between any of the antennas from among the plurality of antennas and calculates the indices based on the correlation.

### Note 3

In the radio communication apparatus described in Note 1, the index calculation unit uses the information to find eigenvalues of the products of a matrix that takes the channels frequency responses as elements and the Hermitian transpose of the matrix and calculates the indices based on the eigenvalues.

### Note 4

In the radio communication apparatus described in Note 1, the index calculation unit uses the information to find vectors that take as elements the channels frequency responses for each antenna provided in the other radio communication apparatus and calculates the indices based on the angles formed between the vectors.

### Note 5

In the radio communication apparatus described in any one of Notes 1 to 4, the index calculation unit calculates indices relating to the angular spread of the channels that is averaged over time or indices relating to the angular spread of the channels that has been averaged across frequencies.

### Note 6

In the radio communication apparatus described in any one of Notes 1 to 5, the weighting factor generation unit generates the weighting factors such that the beam width of directivity that is formed by the plurality of antennas corresponds to the indices.

### Note 7

In the radio communication apparatus described in Note 6, the weighting factor generation unit sets a number of weighting factors to 0, this number according with the indices, and uses the information to generate weighting factors corresponding to antennas in which the weighting factor is not 0.

### Note 8

In the radio communication apparatus described in Note 7, the weighting factor generation unit uses the indices to increase the number of the weighting factors that are set to 0 in proportion to the angular spread of the channel.

### Note 9

In the radio communication apparatus described in Notes 7 or 8, the weighting factor generation unit uses the information to set an upper limit for the number of the weighting factors that are set to 0.

### Note 10

In the radio communication apparatus described in any one of Notes 1 to 9, the weighting factor generation unit uses the indices to determine the number of data blocks to be subjected to spatially multiplexed transmission, and the weighting factor multiplication unit processes signals corresponding to the data blocks that are subjected to spatially multiplexed transmission.

### Note 11

In the radio communication apparatus described in Note 10, the weighting factor generation unit uses the indices to increase the number of the data blocks in proportion to the increase of angular spread of the channels.

### Note 12

In the radio communication apparatus described in any one of Notes 1 to 11, the plurality of antennas include antennas for vertically polarized waves and antennas for horizontally polarized waves, and the index calculation unit calculates the indices corresponding to vertically polarized waves and horizontally polarized waves.

### Note 13

In the radio communication apparatus described in Notes 1 to 12, the plurality of antennas are arranged two-dimensionally in a first direction and a second direction, and the index calculation unit calculates the indices corresponding to each of the first direction and the second direction.

### Note 14

The radio communication method is a radio communication method in a radio communication apparatus that is provided with a plurality of antennas, the method including steps of:

acquiring information relating to channels with another radio communication apparatus;

using the information to calculate indices relating to the angular spread of the channels;

using the information and the indices to generate weighting factors corresponding to each of the plurality of antennas; and

multiplying the signals that are processed at each of the plurality of antennas by the weighting factors corresponding to the antennas that process the signals.

This application claims the benefits of priority based on Japanese Patent Application No. 2013-247676 for which application was submitted on Nov. 29, 2013 and incorporates by citation all of the disclosures of that application.

### EXPLANATION OF REFERENCE NUMBERS

100,600 radio base stations
101-1-101-M, 201-1-201-N antennas
102-1-102-M radio transmission/reception units
103-1-103-M Guard Interval removal units
104-1-104-M Fast Fourier Transform units
105 channel information acquisition unit
106 index calculation unit
107,601 weighting factor generation unit
108, 108-1-108-Q encoding unit
109,109-1-109-Q modulation unit
110,603 weighting factor multiplication unit
111-1-111-M Inverse Fast Fourier Transform units
112-1-112-M Guard Interval insertion units
200, 200-1-200-K radio terminals
602 data block construction unit what is claimed is:

1. A radio communication apparatus that is provided with a plurality of antennas comprising:
a channel information acquisition unit that acquires information relating to channels with another radio communication apparatus;
an index calculation unit that uses said information to calculate indices relating to the angular spread of said channels;
a weighting factor generation unit that uses said information and said indices to generate weighting factors corresponding to each of said plurality of antennas; and
a weighting factor multiplication unit that multiplies the signals that are processed by each of said plurality of antennas by said weighting factors that correspond to the antennas that process the signals.

2. The radio communication apparatus as set forth in claim 1, wherein said index calculation unit uses said information to find a correlation between any antennas from among said plurality of antennas and calculates said indices based on the correlation.

3. The radio communication apparatus as set forth in claim 1, wherein said index calculation unit uses said information to find eigenvalues of the product of a matrix that takes the frequency responses of said channels as elements and the Hermitian transpose of the matrix and calculates said indices based on the eigenvalues.

4. The radio communication apparatus as set forth in claim 1, wherein said index calculation unit uses said information to find vectors that take as elements the frequency responses of said channels for each antenna provided in said other radio communication apparatus and calculates said indices based on the angles formed between said vectors.

5. The radio communication apparatus as set forth in claim 1, wherein said weighting factor generation unit generates said weighting factors such that the beam width of directivity that is formed by said plurality of antennas corresponds to said indices.

6. The radio communication apparatus as set forth in claim 5, wherein said weighting factor generation unit sets a number of said weighting factors to 0, this number according with said indices, and uses said information to generate weighting factors corresponding to antennas in which said weighting factor is not 0.

7. The radio communication apparatus as set forth in claim 1, wherein:
said weighting factor generation unit uses said indices to determine the number of data blocks to be subjected to spatially multiplexed transmission; and
said weighting factor multiplication unit processes signals corresponding to data blocks to be subjected to said spatially multiplexed transmission.

8. The radio communication apparatus as set forth in claim 1, wherein:
said plurality of antennas include antennas for vertical polarization and antennas for horizontal polarization; and
said index calculation unit calculates said indices corresponding to each of vertically polarized waves and horizontally polarized waves.

9. The radio communication apparatus as set forth in claim 1, wherein:
said plurality of antennas are arranged two-dimensionally in a first direction and a second direction; and
said index calculation unit calculates said indices corresponding to each of said first direction and said second direction.

10. A radio communication method in a radio communication apparatus that is provided with a plurality of antennas, comprising steps of:
acquiring information relating to channels with another radio communication apparatus;
using said information to calculate indices relating to the angular spread of said channels;
using said information and said indices to generate weighting factors corresponding to each of said plurality of antennas; and
multiplying the signals that are processed at each of said plurality of antennas by said weighting factors corresponding to antennas that process the signals.
